(19) United States
(12) Patent Application Publication
(10) Pub. No.: US 2021/0362973 A1
(43) Pub. Date: Nov. 25, 2021

(54) MODULE BONDING INSTALLATION APPARATUS, DETECTION DEVICE AND DETECTION METHOD

(71) Applicant: HKC CORPORATION LIMITED, Shenzhen (CN)

(72) Inventor: BEIZHOU HUANG, Shenzhen (CN)

(21) Appl. No.: 16/331,149

(22) PCT Filed: Nov. 12, 2018
(86) PCT No.: PCT/CN2018/114968

§ 371 Date: Mar. 7, 2019

(30) Foreign Application Priority Data
Oct. 16, 2018 (CN) 201811199589.7

(51) Int. Cl. B65H 18/10; G01B 11/02

(52) U.S. Cl. CPC B65H 18/103; G01B 11/026

(57) ABSTRACT

The present application discloses a module bonding installation apparatus, detection device and detection method, thereby controlling recovery of cushion material through detecting by the detection device a feeding length of the cushion material at a cushion material supply end in a unit time.

The present application claims priority to Chinese Patent Application No. 201811199589.7, filed to Chinese Patent Office on Oct. 16, 2018, and entitled “MODULE BONDING INSTALLATION APPARATUS, DETECTION DEVICE AND DETECTION METHOD”, which is incorporated herein by reference in their entirety.

### TECHNICAL FIELD

The present application is in the field of display panel, particularly relates to a module bonding installation apparatus, detection device and detection method.

### BACKGROUND

The statement here merely provides background information relative to the present application, but not necessarily constitutes the prior art.

Active switch controlled displays including a liquid crystal display, an organic light-emitting diode (OLED) display and the like are employed. The liquid crystal display is widely used for having a variety of advantages such as thin, power saving and radiation-free. Where the principle of operation for the liquid crystal panel is to dispose liquid crystal molecules between two parallel glass substrates and apply driving voltage to the two glass substrates so as to control a rotation direction of the liquid crystal molecules, thereby refracting lights from a backlight module for producing a screen. The OLED display has a variety of advantages such as self-lighting, short response time, high definition and contrast, achievable display flexibility and large area for full-color display. The excellent performance and great market potential thereof bring numerous plants and research institutions all around the world to make efforts to production and development of OLED display panels.

In a process of bonding press for chip on glass (COG), a certain pressure and a high temperature is used for bonding the chip onto a glass sheet, cushion material is therefore added for cushioning and uniform heat conduction due to the fragile property of the glass sheet.

The cushion material should be exchanged after several times of pressing since the lifetime of the cushion material is limited. If a feeding length of the cushion material could not be accurately detected, there would be an error for cushion material conveyed every time, possibly resulting in a risk of repeated pressing or cushion material waste.

### SUMMARY

In view of aforementioned disadvantages, the present application is to provide a module bonding installation apparatus, detection device and detection method for detecting a feeding length of cushion material.

To achieve the aforementioned purpose, the present application provides a module bonding installation apparatus, including:

a cushion material supply end, for feeding cushion material;

a cushion material recovery end, configured to recover the cushion material;

a first driver, configured to drive the cushion material supply end to rotate so as to feed the cushion material;

a second driver, configured to drive the cushion material recovery end to rotate so as to recover the cushion material;

a detection device, configured to detect a feeding length of the cushion material at the cushion material supply end in a unit time;

the cushion material being fed by the cushion material supply end and recovered by the cushion material recovery end;

The detection device is in controlled connection with the first or second driver, detects the feeding length of the cushion material at the cushion material supply end in a unit of time, feeds detection results back to the first or second driver and controls the first driver to drive rotation of the cushion material supply end or controls the second driver to drive rotation of the cushion material recovery end.

Optionally, the cushion material detection device includes: a sensor which detects a parameter of distance thereof from the cushion material at the cushion material supply end, and a computing mechanism which acquires from the sensor the parameter of distance from the cushion material at the cushion material supply end to the sensor, calculates the feeding length of the cushion material at the cushion material supply end in the unit time, feeds a calculation result back to the first or second driver module and controls the first driver module to drive the rotation of the cushion material supply end or controls the second driver module to drive the rotation of the cushion material recovery end.

Optionally, the cushion material supply end includes a cushion material tube, around which the cushion material is wound;

the sensor includes a laser displacement sensor which detects a distance A thereof from the cushion material at the cushion material supply end;

the laser displacement sensor has a distance D from a center of the cushion material tube at the cushion material supply end;

a laser ray emitted by the laser displacement sensor is incident perpendicularly to a direction tangential to a circumference of the cushion material tube, and a straight line where the laser lay emitted by the laser displacement sensor located passes through the center of the cushion material tube.

Optionally, a whole roll of cushion material wound around the cushion material tube has a radius of R, and the distance D between the sensor and the center of the cushion material tube at the cushion material supply end is no more than 3 times the radius R of the whole roll of cushion material wound around the cushion material tube.

The present application further discloses a detection device for detecting a module bonding installation apparatus, the module bonding installation apparatus including:

a cushion material supply end, configured to feed cushion material;

a cushion material recovery end, configured to recover the cushion material;

a first driver, configured to drive the cushion material supply end to rotate so as to feed the cushion material;

a second driver, configured to drive the cushion material recovery end to rotate so as to recover the cushion material;

the cushion material being fed by the cushion material supply end and recovered by the cushion material recovery end;

the detection device including: a sensor which detects a parameter of distance thereof from the cushion material at the cushion material supply end, and a computing mechanism which acquires from the sensor the parameter of distance from the cushion material at the cushion material supply end to the sensor, calculates the feeding length of the cushion material at the cushion material supply end in the unit time, feeds a calculation result back to the first or second driver and controls the first driver to drive the rotation of the cushion material supply end or controls the second driver to drive the rotation of the cushion material recovery end.

The present application further discloses a detection method for a module bonding installation apparatus, including:

detection step: a cushion material detection device detecting a feeding length of the cushion material at a cushion material supply end in a unit time;

and feedback and control step: feeding a detection result back to a first or second driver and controlling the first driver to drive rotation of the cushion material supply end or controlling the second driver to drive rotation of a cushion material recovery end.

Optionally, at the detection step, a sensor detects a parameter of distance thereof from the cushion material at the cushion material supply end;

at the feedback and control step, a computing mechanism acquires from the sensor the parameter of distance from the cushion material at the cushion material supply end to the sensor, calculates the feeding length of the cushion material at the cushion material supply end in the unit time and feeds a calculation result back to the first or second driver.

Optionally, the cushion material supply end includes a cushion material tube, around which the cushion material is wound;

the sensor includes a laser displacement sensor, a laser ray emitted by the laser displacement sensor is incident perpendicularly to a direction tangential to a circumference of the cushion material tube, and a straight line where the laser lay emitted by the laser displacement sensor located passes through the center of the cushion material tube;

the laser displacement sensor detects a distance A thereof from the cushion material at the cushion material supply end;

the laser displacement sensor has a distance D from a center of the cushion material tube at the cushion material supply end; a circumstance C of the cushion material at this time may be derived from a formula C=2π(D−A);

In a formula W=L/((2π(D−A)/360), L is a feeding quantity of cushion material in a single time and W is an angle of rotation for a feeding motor.

Optionally, at the detection step, the laser displacement sensor detects the distance thereof from the cushion material at the cushion material supply end in real time;

At the feedback and control step, the computing mechanism acquires from the laser displacement mechanism the distance from the cushion material at the cushion material supply end to the laser displacement sensor, feeds back to the first or second driver module in real time, and controls the first driver module to drive the rotation of the cushion material supply end or controls the second driver module to drive the rotation of the cushion material recovery end; the detection step is synchronously performed with the feedback and control step.

Optionally, at the detection step, given one operation of a bonding press head as a detection cycle, the distance from the cushion material at the cushion material supply end to the laser displacement sensor is detected;

at the feedback and control step, the computing mechanism acquires from the laser displacement mechanism the distance from the cushion material at the cushion material supply end to the laser displacement sensor, feeds back to the first or second driver module in real time, controls the first driver module to drive the rotation of the cushion material supply end or controls the second driver module to drive the rotation of the cushion material recovery end, and waits for the next detection cycle.

The feeding motor rotates when the module bonding installation apparatus supplies cushion material, so as to drive the supply of cushion material; however, it is impossible to detect whether the cushion material is supplied or not since the feeding length of cushion material in a single rotation is an analogue length rather than an actually exact quantification value, resulting in repeat pressing at one pressing position of the bonding press head. The precise feeding length of the cushion material may be indirectly determined by increasing the number of sensors. Also, the installation of sensors is relatively convenience and highly feasible, and great changes are not necessary for the reconstruction thereof. Thus, it is possible to measure the feeding length of the cushion material when module bonding is performed, thereby avoiding rejects due to repeat pressing caused by inappropriate rotation of cushion material and reducing cost waste for cushion material as well.

### BRIEF DESCRIPTION OF DRAWINGS

The drawings are included to provide understanding of embodiments of the present application, which constitute a part of the specification and illustrate the embodiments of the present application, and describe the principles of the present application together with the text description. Apparently, the accompanying drawings in the following description show merely some embodiments of the present application, and a person of ordinary skill in the art may still derive other accompanying drawings from these accompanying drawings without creative efforts. In the accompanying drawings:

FIG. 1 is a schematic diagram for a module bonding installation according to embodiments of the present application;

FIG. 2 is a schematic diagram for the module bonding installation apparatus and a detection device of embodiments of the present application;

FIG. 3 is a schematic diagram for a cushion material supply end and the detection device of embodiments of the present application; and

FIG. 4 is a schematic diagram for steps of a cushion material detection method of embodiments of the present application.

### DETAILED DESCRIPTION

The specific structure and function details disclosed herein are merely representative, and are intended to describe exemplary embodiments of the present application. However, the present application can be specifically embodied in many alternative forms, and should not be interpreted to be limited to the embodiments described herein.

In the description of the present application, it should be understood that, orientation or position relationships indicated by the terms “center”, “transversal”, “upper”, “lower”, “left”, “right”, “vertical”, “horizontal”, “top”, “bottom”, “inner”, “outer”, etc. are based on the orientation or position relationships as shown in the drawings, for ease of the description of the present application and simplifying the description only, rather than indicating or implying that the indicated device or element must have a particular orientation or be constructed and operated in a particular orientation. Therefore, these terms should not be understood as a limitation to the present application. In addition, the terms such as “first” and “second” are merely for a descriptive purpose, and cannot be understood as indicating or implying a relative importance, or implicitly indicating the number of the indicated technical features. Hence, the features defined by “first” and “second” can explicitly or implicitly include one or more features. In the description of the present application, “a plurality of” means two or more, unless otherwise stated. In addition, the term “include” and any variations thereof are intended to cover a non-exclusive inclusion.

In the description of the present application, it should be understood that, unless otherwise specified and defined, the terms “install”, “connected with”, “connected to” should be comprehended in a broad sense. For example, these terms may be comprehended as being fixedly connected, detachably connected or integrally connected; mechanically connected or electrically connected; or directly connected or indirectly connected through an intermediate medium, or in an internal communication between two elements. The specific meanings about the foregoing terms in the present application may be understood by those skilled in the art according to specific circumstances.

The terms used herein are merely for the purpose of describing the specific embodiments, and are not intended to limit the exemplary embodiments. As used herein, the singular forms “a”, “an” are intended to include the plural forms as well, unless otherwise indicated in the context clearly. It will be further understood that the terms “comprise” and/or “include” used herein specify the presence of the stated features, integers, steps, operations, elements and/or components, but do not preclude the presence or addition of one or more other features, integers, steps, operations, elements, components and/or combinations thereof.

The present application is illustrated in conjunction with the drawings and optional embodiments as follows.

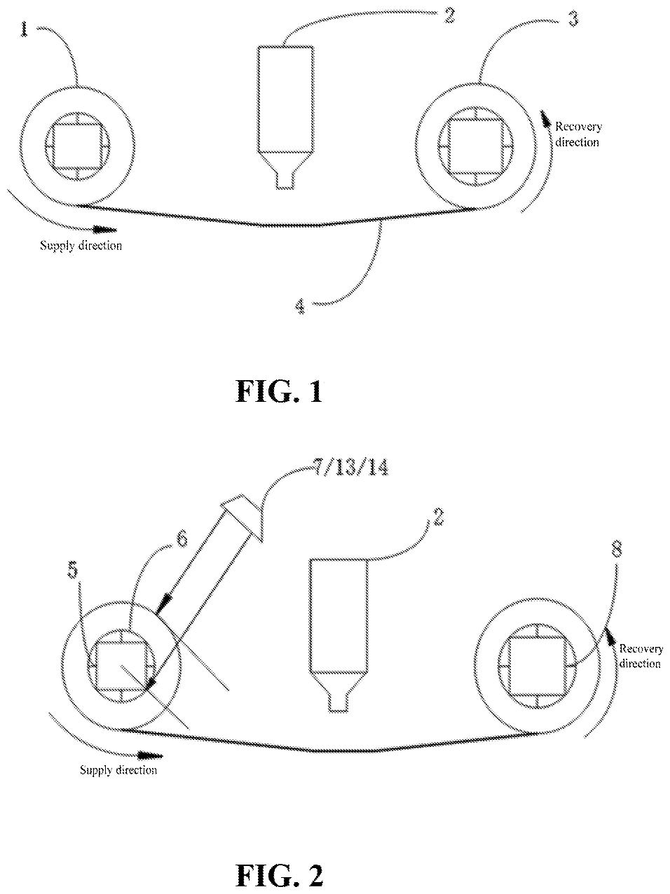

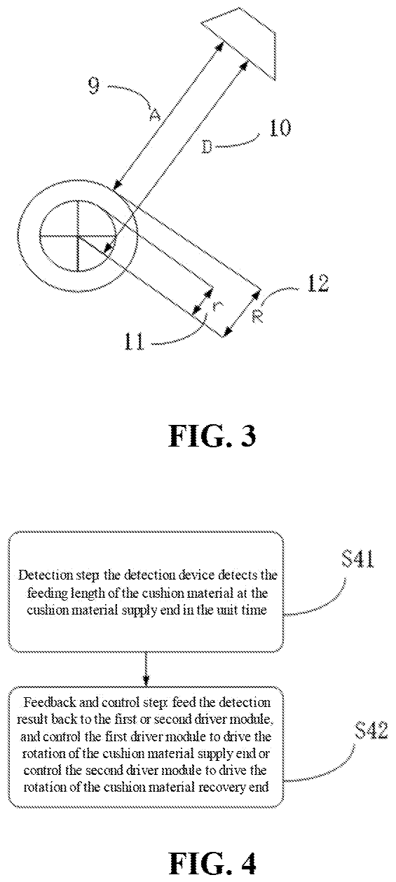

As shown in FIGS. 1-3, a module bonding installation apparatus is disclosed In one or more embodiments of the present application, including: a cushion material supply end 1 for feeding the cushion material 4, cushion material recovery end 3 for recovering the cushion material 4, bonding press head 2 for module bonding, a first driver 5 for driving the cushion material supply end 1 to rotate so as to feed the cushion material 4, a second driver 8 for driving the cushion material recovering end 3 to rotate so as to recover the cushion material 4, and a detection device 14 for detecting the feeding length of the cushion material 4 at the cushion material supply 1 in a unit time.

The cushion material 4 is fed by the cushion material supply end 1, processed by the bonding press head 2 and recovered by the cushion material recovery end 3.

The detecting device 14 is in controlled connection with the first driver 5 or the second driver 8, detects the feeding length of the cushion material at the cushion material supply end 1 in the unit time, feeds a detection result back to the first driver 5 or the second driver 8, and controls the first driver 5 to drive rotation of the cushion material supply end 1 or controls the second driver 8 to drive rotation of the cushion material recovery end 3.

In this embodiment, the first driver 5 and the second driver 8 are respectively driven by a motor. The cushion material supply end and the cushion material recovery end are driven to rotate through the rotation of the motors, so as to feed and recover the cushion material.

The feeding motor rotates when the module bonding installation apparatus supplies the cushion material 4, so as to drive the supply of the cushion material 4; however, it is impossible to detect whether the cushion material 4 is supplied or not since the feeding length of the cushion material 4 in a single rotation is an analogue length rather than a substantially exact quantification value, resulting in repeat pressing at one pressing position of the bonding press head 2. In practical application, since the cushion material 4 has a limited number of times for cushioning action, the pressing position is repeatedly pressed as the cushion material 4 loses its primary characteristic after it is used too many times. The precise feeding length of the cushion material 4 may be indirectly determined by increasing the number of sensors 7. Also, the installation of the sensors 7 is relatively convenience and highly feasible, and great changes are not necessary for the reconstruction thereof. Thus, it is possible to measure the feeding length of the cushion material 4 when module bonding is performed, thereby avoiding rejects due to repeat pressing caused by inappropriate rotation of the cushion material 4 and reducing cost waste for cushion material 4 as well.

In one or more embodiments, the detection device 14 includes: a sensor 7 which detects a parameter of distance thereof from the cushion material 4 at the cushion material supply end 1, and a computing mechanism which acquires from the sensor 7 the parameter of distance from the cushion material 4 at the cushion material supply end 1 to the sensor 7, calculates the feeding length of the cushion material 4 at the cushion material supply end 1 in the unit time, feeds a calculation result back to the first driver 5 or the second driver 8 and controls the first driver 5 to drive the rotation of the cushion material supply end 1 or controls the second driver 8 to drive the rotation of the cushion material recovery end 3.

In one or more embodiments, the sensor 7 uses a laser displacement sensor 13.

A laser ray emitted by the laser displacement sensor 13 is reflected back to the laser displacement sensor 13 when it has encountered an object. The sensor 7 detects a light signal and records the time elapsed when the laser ray passes through the distance so as to derive the distance passed through per unit time, thereby calculating a distance between the laser displacement sensor 13 and the cushion material 4 at the cushion material supply end 1. The laser displacement sensor 13 is more real time and more accurate in detection in relative to the other sensors 7, such that the feeding length of the cushion material 4 is determined more accurately and in time, and then transmitted to the computing mechanism for calculation so as to provide an accurate length of the cushion material 4.

In one or more embodiments, the cushion material supply end 1 includes a cushion material tube 6, around which the cushion material 4 is wound. The laser displacement sensor 13 detects a distance A thereof from the cushion material 4 at the cushion material supply end 1. The laser displacement sensor 13 has a distance D from the center of the cushion material tube 6 at the cushion material supply end 1. The laser ray emitted by the laser displacement sensor 13 is incident perpendicularly to a direction tangential to a circumference of the cushion material tube 6, and a straight line where the laser lay emitted by the laser displacement sensor 13 located passes through the center of the cushion material tube 6.

It is possible to accurately calculate the distance between the cushion material 4 on the cushion material tube 6 and the laser displacement sensor 13 as a vertical distance only if the laser ray is perpendicular to the tangent line of the circumference of the cushion material tube 6, while the distance between the cushion material tube 6 and the laser displacement sensor 13 is shorter only if the straight line where the laser ray is located passes through the center. That is to say, if data of the desired distance A between the laser displacement sensor 13 and the cushion material tube 6 at the cushion material supply end 1 is not accurate, there would be an effect on a radius (D−A) of the cushion material 4 wound around the cushion material tube 6, namely an error is resulted in for the calculation of the circumference of the cushion material 4. Therefore, the feeding length of the cushion material 4 cannot be precisely calculated.

In one or more embodiments, a whole roll of cushion material 4 wound around the cushion material tube 6 has a radius of R, and the distance D between the laser displacement sensor 13 and the center of the cushion material tube 6 at the cushion material supply end 1 is no more than 3 times the radius R of the whole roll of cushion material 4 wound around the cushion material tube 6.

If D is much greater than the radius (D−A) of the cushion material 4 actually wound around the cushion material tube 6, then the time for the laser ray incoming to the cushion material 4 is not much different than that for incoming to the center of the cushion material tube 6, resulting in a large error of the radius (D−A) of the cushion material 4 actually wound around the cushion material tube 6, which has an effect on the actual error of the whole apparatus.

As another embodiment of the present application, with reference to FIGS. 1-3, disclosed is a detection device for detecting the module bonding installation apparatus. The module bonding installation apparatus includes: a cushion material supply end for feeding cushion material 4; a cushion material recovery end 3 for recovering the cushion material 4;

a bonding press head 2 for module bonding; a first driver 5 for driving the cushion material supply end 1 to rotate so as to feed the cushion material; a second driver 8 for driving the cushion material recovery end 3 to rotate so as to recover the cushion material 4.

The cushion material 4 is fed by the cushion material supply end 1, processed by the bonding press head 2 and recovered by the cushion material recovery end 3.

The detection device 14 includes: a sensor 7 which detects a parameter of distance thereof from the cushion material 4 at the cushion material supply end 1, and a computing mechanism which acquires from the sensor 7 the parameter of distance from the cushion material 4 at the cushion material supply end 1 to the sensor 7, calculates the feeding length of the cushion material 4 at the cushion material supply end 1 in the unit time, feeds a calculation result back to the first driver 5 or the second driver 8 and controls the first driver 5 to drive the rotation of the cushion material supply end 1 or controls the second driver 8 to drive the rotation of the cushion material recovery end 3.

In one or more embodiments, the sensor may be a laser displacement sensor, or may be an image sensor, an infrared distance sensor and other sensor that could calculate a distance.

The feeding motor rotates when the module bonding installation apparatus supplies the cushion material 4, so as to drive the supply of the cushion material 4; however, it is impossible to detect whether the cushion material 4 is supplied or not since the feeding length of the cushion material 4 in a single rotation is an analogue length rather than a substantially exact quantification value, resulting in repeat pressing at one pressing position of the bonding press head 2. The precise feeding length of the cushion material 4 may be indirectly determined by increasing the number of the laser displacement sensors 13. Also, the installation of the laser displacement sensors 7 is relatively convenience and highly feasible, and great changes are not necessary for the reconstruction thereof. Thus, it is possible to measure the feeding length of the cushion material 4 when module bonding is performed, thereby avoiding rejects due to repeat pressing caused by inappropriate rotation of the cushion material 4 and reducing cost waste for cushion material 4 as well.

As another embodiment of the present application, with reference to FIGS. 1-4, disclosed is a detection method for a module bonding installation apparatus, including:

S41: detection step: the detection device 14 detects the feeding length of the cushion material 4 at the cushion material supply end 1 in a unit time.

S42: feedback and control step: feed a detection result back to a first driver 5 or a second driver 8 and control the first driver 5 to drive rotation of the cushion material supply end 1 or control the second driver 8 to drive rotation of a cushion material recovery end 3.

Through detecting the feeding length of the cushion material 4 at the cushion material supply end 1 in the unit time and feeding the detection result back to the supply end or the recovery end, the supply end feeds desired feeding length of cushion material or the recovery end recovers desired feeding length so as to drive the rotation of the supply end, which is simple, practical and capable of precisely measuring the feeding length of the cushion material 4, avoiding rejects due to inappropriate rotation of the cushion material 4 and reducing cost waste for the cushion material 4 as well.

In one or more embodiments, in the detection step, the sensor 7 detects a parameter of distance thereof from the cushion material 4 at the cushion material supply end 1;

At the feedback and control step, the computing mechanism acquires from the sensor 7 the parameter of distance from the cushion material 4 at the cushion material supply end 1 to the sensor 7, calculates the feeding length of the cushion material 4 at the cushion material supply end 1 in the unit time, feeds the calculation result back to the first driver 5 or the second driver 8, and controls the first driver 5 to drive the rotation of the cushion material supply end 1 or controls the second driver 8 to drive the rotation of the cushion material recovery end 3.

A laser ray emitted by the laser displacement sensor 13 is reflected back to the laser displacement sensor 13 when it has encountered an object. The laser displacement sensor 13 detects a light signal and records the time elapsed when the laser ray passes through the distance so as to derive the distance passed through per unit time, thereby calculating a distance between the laser displacement sensor 13 and the cushion material 4 at the cushion material supply end 1. The laser displacement sensor 13 is more real time and more accurate in detection in relative to the other sensors 7, such that the feeding length of the cushion material 4 is determined more accurately and in time, and then transmitted to the computing mechanism for calculation so as to provide an accurate length of the cushion material 4.

In one or more embodiments, the cushion material supply end 1 includes a cushion material tube 6 around which the cushion material 4 is wound.

The laser ray emitted by the laser displacement sensor 13 is incident perpendicularly to a direction tangential to the circumference of the cushion material tube 6, and a straight line where the laser lay emitted by the laser displacement sensor 13 located passes through the center of the cushion material tube 6. The laser displacement sensor 13 detects a distance A thereof from the cushion material 4 at the cushion material supply end 1. The laser displacement sensor 13 has a distance D from the center of the cushion material tube 6 at the cushion material supply end 1. The circumstance C of the cushion material 4 at this time may be derived from the formula C=2π(D−A). In the formula W=L/((2π(D−A)/360), L is the feeding quantity of the cushion material 4 in a single time and W is an angle of rotation for the feeding motor.

As the feeding length of the cushion material 4 in a single rotation of the module boding installation apparatus is an analogue length rather than a substantially exact quantification value, it is a technical challenge that the cushion material 4 around the cushion material tube 6 becomes less as the cushion material 4 is supplied, causing a difference between the lengths of the cushion material 4 output by a previous rotation and a current rotation of the feeding motor. The key point is to work out a precise angle for each rotation of the feeding motor, so as to accurately calculate the length of the cushion material 4 output in a single time. In the present application, a laser ray emitted by the laser displacement sensor 13 is reflected back to the laser displacement sensor 13 when it has encountered an object. The sensor 7 detects a light signal and records the time elapsed when the laser ray passes through the distance so as to derive the distance passed through per unit time, thereby calculating the distance A between the laser displacement sensor 13 and the cushion material 4 at the cushion material supply end 1. Then the distance between the laser displacement sensor 13 and the center of the cushion material tube 6 at the cushion material supply end 1 is measured so as to derive a real-time radius (D−A) of the cushion material tube 6 from the edge of the cushion material 4 thereon to the center thereof. The length of one circle of cushion material 4 wound around the cushion material tube 6 at this time can be derived from the formula C=2π(D−A). Thus, the length of the cushion material 4 in each degree is C/130. According to a feeding length L of the cushion material 4 required to be supplied in a single time, a desired angle of rotation for the feeding motor is derived from the formula W=L/((2π(D−A)/360). Accordingly, a substantially exact quantification value may be worked out so as to precisely determine whether the cushion material 4 is fed by rotation.

In one or more embodiments, at the detection step, the laser displacement sensor 13 detects the distance thereof from the cushion material 4 at the cushion material supply end 1 in real time:

at the feedback and control step, the computing mechanism acquires from the laser displacement mechanism 13 the distance from the cushion material 4 at the cushion material supply end 1 to the laser displacement sensor 13, feeds back to the first driver 5 or the second driver 8 in real time, and controls the first driver 5 to drive the rotation of the cushion material supply end 1 or controls the second driver 8 to drive the rotation of the cushion material recovery end 3; the detection step is synchronously performed with the feedback and control step.

The real-time detection is advantageous. The motor is required to rotate more than one revolution if W is calculated to be larger than 360°. In the case of intermittent detection, the cushion material 4 would be output in the second revolution according to the circumference of the first round. However, the second revolution would reduce the thickness of the cushion material 4, so that the circumference at the desired angle of rotation needs to be shorter than that at the rotated angle in the formula for calculation, resulting in an insufficient feeding length of the cushion material 4 and an effect on the operation of the bonding press head 2. The real-time detection and control is able to supplement a new angle in the second revolution in order to ensure the desired output length of the cushion material 4.

In one or more embodiments where the thickness of the cushion material 4 is ignored, the module bonding apparatus further includes a bonding press head 2 for module bonding. The cushion material 4 is fed by the cushion material supply end 1, processed by the bonding press head 2 and recovered by the cushion material recovery end 3.

At the detection step, given one operation of the bonding press head 2 as a detection cycle, the distance from the cushion material 4 at the cushion material supply end 1 to the laser displacement sensor 13 is detected.

At the feedback and control step, the distance from the cushion material 4 at the cushion material supply end 1 to the laser displacement sensor 13 is fed back to the first driver 5 or the second driver 8 in real time so as to control the first driver 5 to drive the rotation of the cushion material supply end 1 or control the second driver 8 to drive the rotation of the cushion material recovery end 3 and wait for the next detection cycle.

The intermittent detection may be performed when the thickness of the cushion material 4 is ignored. It is advantageous that no error is caused due to the thickness of the cushion material 4 when more than one revolution is performed. At the same time, the emission frequency of the laser displacement sensor 13 may be controlled so as to avoid continuous emission of the laser displacement sensor 13, which causes data accumulation and power consumption and even a fault of the laser displacement sensor 13.

The foregoing are detailed description of the present application provided in connection with specific optional embodiments and are not considered as limiting the embodiments of the present application. Various simple deductions and substitutions may be made by persons of ordinary skills in the art of the present application without departing from the spirit of the present application and should be considered as within the scope of protection of the present application.

What is claimed is:

1. A module bonding installation apparatus, comprising:
a cushion material supply end, configured to feed cushion material;
a cushion material recovery end, configured to recover the cushion material;
a first driver, configured to drive the cushion material supply end to rotate so as to feed the cushion material;
a second driver, configured to drive the cushion material recovery end to rotate so as to recover the cushion material;
and a detection device, configured to detect a feeding length of the cushion material at the cushion material supply end in a unit time;
the cushion material being fed by the cushion material supply end and recovered by the cushion material recovery end;
the detection device being in controlled connection with the first or second driver, detecting the feeding length of the cushion material at the cushion material supply end in the unit time, feeding a detection result back to the first or second driver and controlling the first driver to drive rotation of the cushion material supply end or controlling the second driver to drive rotation of the cushion material recovery end.

2. The module bonding installation according to claim 1, wherein the detection device comprises: a sensor which detects a parameter of distance thereof from the cushion material at the cushion material supply end, and a computing mechanism which acquires from the sensor the parameter of distance from the cushion material at the cushion material supply end to the sensor, calculates the feeding length of the cushion material at the cushion material supply end in the unit time and feeds a calculation result back to the first or second driver.

3. The module bonding installation according to claim 2, wherein the sensor comprises a laser displacement sensor which detects a distance A thereof from the cushion material at the cushion material supply end, and the computing mechanism acquires a parameter of distance A between the laser displacement sensor and the cushion material at the cushion material supply end.

4. The module bonding installation according to claim 3, wherein the cushion material supply end comprises a cushion material tube, around which the cushion material is wound;
the laser displacement sensor has a distance D from a center of the cushion material tube at the cushion material supply end;
a laser ray emitted by the laser displacement sensor is incident perpendicularly to a direction tangential to a circumference of the cushion material tube, and a straight line where the laser lay emitted by the laser displacement sensor located passes through the center of the cushion material tube.

5. The module bonding installation according to claim 4, wherein a whole roll of cushion material wound around the cushion material tube has a radius of R, and the distance D between the sensor and the center of the cushion material tube at the cushion material supply end is no more than 3 times the radius R of the whole roll of cushion material wound around the cushion material tube.

6. The module bonding installation according to claim 4, comprising bonding press head, wherein the cushion material is fed by the cushion material supply end, processed by the bonding press head and recovered by the cushion material recovery end.

7. A detection device for detecting a module bonding installation apparatus, the module bonding installation apparatus comprising:
a cushion material supply end, configured to feed cushion material;
a cushion material recovery end, configured to recover the cushion material;
a first driver, configured to drive the cushion material supply end to rotate so as to feed the cushion material;
a second driver, configured to drive the cushion material recovery end to rotate so as to recover the cushion material;
the cushion material being fed by the cushion material supply end and recovered by the cushion material recovery end;
the detection device being in controlled connection with the first or second driver,
the detection device comprising: a sensor which detects a parameter of distance thereof from the cushion material at the cushion material supply end, and a computing mechanism which acquires from the sensor the parameter of distance from the cushion material at the cushion material supply end to the sensor, calculates the feeding length of the cushion material at the cushion material supply end in a unit time, feeds a calculation result back to the first or second driver and controls the first driver to drive rotation of the cushion material supply end or controls the second driver to drive rotation of the cushion material recovery end.

8. A detection method for a module bonding installation apparatus, the module bonding installation apparatus comprising:
a cushion material supply end, configured to feed cushion material;
a cushion material recovery end, configured to recover the cushion material;
a first driver, configured to drive the cushion material supply end to rotate so as to feed the cushion material;
a second driver, configured to drive the cushion material recovery end to rotate so as to recover the cushion material;
and a detection device, configured to detect a feeding length of the cushion material at the cushion material supply end in a unit time;
the cushion material being fed by the cushion material supply end and recovered by the cushion material recovery end;
the detection device being in controlled connection with the first or second driver, detecting the feeding length of the cushion material at the cushion material supply end in the unit time, feeding a detection result back to the first or second driver and controlling the first driver to drive rotation of the cushion material supply end or controlling the second driver to drive rotation of the cushion material recovery end;
the detection method comprising steps of:
detection step: the detection device detecting the feeding length of the cushion material at the cushion material supply end in the unit time;
and feedback and control step: feeding the detection result back to the first or second driver and controlling the first driver to drive the rotation of the cushion material supply end or controlling the second driver to drive the rotation of the cushion material recovery end.

9. The detection method for a module bonding installation according to claim 8, wherein the detection device comprises: a sensor which detects a parameter of distance thereof from the cushion material at the cushion material supply end, and a computing mechanism which acquires from the sensor the parameter of distance from the cushion material at the cushion material supply end to the sensor, calculates the feeding length of the cushion material at the cushion material supply end in the unit time and feeds a calculation result back to the first or second driver.

10. The detection method for a module bonding installation according to claim 9, wherein the sensor comprises a laser displacement sensor which detects a distance A thereof from the cushion material at the cushion material supply end, and the computing mechanism acquires a parameter of distance A between the laser displacement sensor and the cushion material at the cushion material supply end.

11. The detection method for a module bonding installation according to claim 10, wherein the cushion material supply end comprises a cushion material tube, around which the cushion material is wound;
the laser displacement sensor has a distance D from a center of the cushion material tube at the cushion material supply end;
a laser ray emitted by the laser displacement sensor is incident perpendicularly to a direction tangential to a circumference of the cushion material tube, and a straight line where the laser lay emitted by the laser displacement sensor located passes through the center of the cushion material tube.

12. The detection method for a module bonding installation according to claim 11, wherein a whole roll of cushion material wound around the cushion material tube has a radius of R, and the distance D between the sensor and the center of the cushion material tube at the cushion material supply end is no more than 3 times the radius R of the whole roll of cushion material wound around the cushion material tube.

13. The detection method for a module bonding installation according to claim 12, comprising:
at the detection step, the sensor detecting a parameter of distance thereof from the cushion material at the cushion material supply end;
at the feedback and control step, the computing mechanism acquiring from the sensor the parameter of distance from the cushion material at the cushion material supply end to the sensor, calculating the feeding length of the cushion material at the cushion material supply end in the unit time and feeding the calculation result back to the first or second driver.

14. The detection method for a module bonding installation according to claim 13, wherein the first driver comprises a feeding motor;
at the feedback and control step, the computing mechanism feeds the calculation result back to the first driver, and the first driver controls the motor to rotate.

15. The detection method for a module bonding installation according to claim 14, comprising:
at the feedback step, according to the formula W=L/((2π(D−A)/360) where L is a feeding quantity of cushion material in a single time and W is an angle of rotation for the feeding motor, the computing mechanism calculating the angle of rotation W for the feeding motor and feeding the angle of rotation W back to the feeding motor.

16. The detection method for a module bonding installation according to claim 15, comprising:
at the detection step, the laser displacement sensor detecting the distance thereof from the cushion material at the cushion material supply end in real time;
at the feedback and control step, the computing mechanism acquiring from the laser displacement mechanism the distance from the cushion material at the cushion material supply end to the laser displacement sensor and feeding back to the first or second driver in real time;
wherein the detection step is synchronously performed with the feedback and control step.

17. The detection method for a module bonding installation according to claim 15, comprising:
at the detection step, given one operation of a bonding press head as a detection cycle, detecting the distance from the cushion material at the cushion material supply end to the laser displacement sensor;
at the feedback and control step, the computing mechanism acquiring from the laser displacement mechanism the distance from the cushion material at the cushion material supply end to the laser displacement sensor, feeding back to the first or second driver in real time, controlling the first driver to drive the rotation of the cushion material supply end or controlling the second driver to drive the rotation of the cushion material recovery end, and waiting for the next detection cycle.
